(19) United States
(12) Patent Application Publication
(10) Pub. No.: US 2011/0041124 A1
(43) Pub. Date: Feb. 17, 2011

(54) Version Management System

(76) Inventors: Neil S. Fishman, Bothell, WA (US); Christopher H. Phillips, Kirkland, WA (US)

Correspondence Address: MICROSOFT CORPORATION, ONE MICROSOFT WAY, REDMOND, WA, 98052, US

(21) Appl. No.: 12/541,996

(22) Filed: Aug. 17, 2009

(51) Int. Cl. G06F 9/445; G06F 11/00

(52) U.S. Cl. 717/170; 726/23; 717/171; 717/176

(57) ABSTRACT

A version management system may maintain an updated installation package for a software application as the application is updated from time to time. The updated installation package may allow the application to be reinstalled using the updated installation package without having to start with an original installation package and apply successive updates. In one embodiment, a distribution medium may have a read only memory location containing an original installation package and a read/write memory location that may contain updated installation packages that are created as updates are received and applied. In some cases, the updated installation packages may include various system state parameters, as well as configuration information for the managed software system as well as related software products.

### BACKGROUND

Many software systems have an update procedure where the software system may be periodically updated. For example, operating systems and various applications may be updated with security updates, functional updates, bug fixes, or other updates over time. It is not uncommon for some software systems to have many tens or even hundreds of updates over the lifecycle of the software system.

In a typical distribution mechanism for software, a Compact Disk (CD), Digital Versatile Disk (DVD), or other media may be used to transport the software from a manufacturer to a user. In cases where the software is frequently updated, updates may have been issued between the time the medium was manufactured and the time the user performed an installation. In such a case, the user may download updates from the manufacturer immediately after installation.

When a user wishes to re-install the software at a later date, there may be many tens or even hundreds of updates that may be downloaded and installed.

### SUMMARY

A version management system may maintain an updated installation package for a software application as the application is updated from time to time. The updated installation package may allow the application to be reinstalled using the updated installation package without having to start with an original installation package and apply successive updates. In one embodiment, a distribution medium may have a read only memory location containing an original installation package and a read/write memory location that may contain updated installation packages that are created as updates are received and applied. In some cases, the updated installation packages may include various system state parameters, as well as configuration information for the managed software system as well as related software products.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a version management system for various software systems.

FIG. 2 is a diagram illustration of an embodiment showing an example of a distribution medium with version management.

FIG. 3 is a flowchart illustration of an embodiment showing a method for managing versions of a software system.

### DETAILED DESCRIPTION

A version management system may create updated versions of installation packages for software applications as the software applications are updated over time. As changes are made to an application, an installation package may be created that incorporates the change. In many cases, the change may be a distributed update from a software manufacturer, while in other cases the change may be changes to the application configuration, system state, or other information that may allow the application to be reinstalled in the same state or close to the same state as the application is executed. When an updated installation package is used to reinstall a software system, the software system may operate a very similarly, if not identical, to the last updated configuration.

In one embodiment, a distribution mechanism for software may be a device that contains read/write storage. A version management system may keep an updated version of a software installation package in the read/write storage area, and may have the originally distributed software in a read only storage area. In such an embodiment, the distribution mechanism may be continually attached to a client device in order to receive updated installation packages.

In another embodiment, a version management system may register several software applications to manage. For each managed application, any updates to the application may be captured in an updated installation package for that application. The updated installation packages may be stored in a local or remote storage system. Such systems may operate on the client device or on a remote server.

In many embodiments, an update may be applied to a client device and then used to update an installation package at a later time. In some embodiments, a background process may update an installation package at a time when the client device resources are not being used for other functions. For example, such a background process may operate at night when a user is away from the client device.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

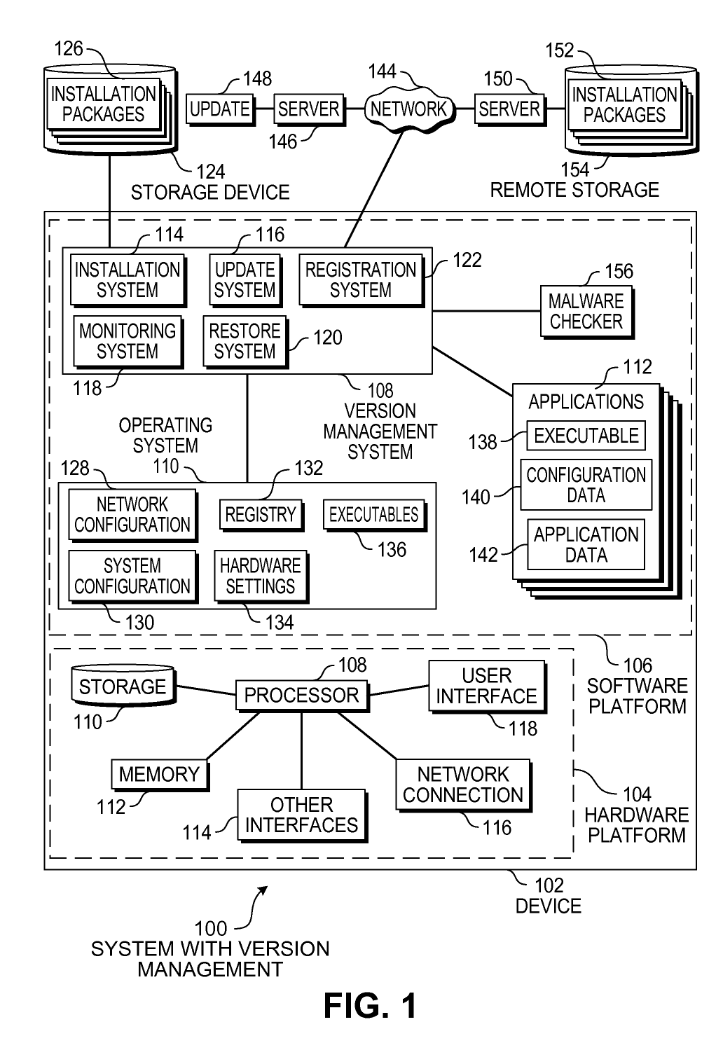

FIG. 1 is a diagram of an embodiment 100 showing a system with a version management system. Embodiment 100 is a simplified example of a version management system that may maintain updated installation packages for applications and other software systems.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a deployment of a version management system. The version management system may monitor changes to an application or other software system and may apply updates to an installation package so that a re-installation will result in the updated software system, rather than the original software system to which various updates and changes may be applied afterwards.

The version management system may operate on any type of software system that may be updated or changed after installation. In some cases, the software system may be an operating system, application, suite of applications, service, or other software system.

The software system may be deployed using an installation package, which may come in many forms. The installation package may be any mechanism that may be used to install the software system. Some applications, for example, may have a single installation file from which several files may be unpacked and used to install the applications. In some cases, a special installation application may perform the installation, which may include creating directories, unpacking and storing files, updating system registries, performing queries and updating configuration files and other settings, as well as other operations. Some installation packages may be in the form of multiple files and may have other installation mechanisms.

For the purposes of this specification and claims, the term “installation package” may include any form of data, executable, or other information that may be used to install a software system. The software system may be a single file or multiple files, and may include additional components, such as registry settings or configuration data that are implemented during an installation process. The “installation package” may be whatever data, executables, or other information may be supplied to perform an installation.

In some embodiments, a separate software application may process an installation package and perform many operations, such as unpacking files, creating directories, and applying configuration settings. In other embodiments, the installation package may be self contained where the mechanisms for performing the installation process may be contained within the installation package.

In many embodiments, an installation package may be compressed to take up less space on a distribution medium. In many such embodiments, a single compressed file may contain multiple individual files. Some such embodiments may be a self extracting file that may create one or more temporary files, one of which may be executed to perform an installation.

Many software systems may be updated periodically. Updates may occur for many different reasons, such as bug fixes, enhanced functionality, security fixes, or other reasons. Some software systems may be updated very frequently, such as malware monitoring systems that may be updated several times a day. Other software systems may be updated rather infrequently, such as stable applications that may have updates annually or whenever a change is distributed.

In many cases, updates may come in the form of a file from a software manufacturer. The file may be used by the application itself or an installation application to make changes to the software system.

In some cases, updates may consist of configuration changes made after the software system is operational. For example, a user may modify the configuration of a software system, or the software system settings may be changed by another application, operating system, or other mechanism. Such configuration changes may be managed by a version management system in the same manner as a distributed update file or other update mechanism.

The version management system may manage installation packages by applying updates to an older installation package to create a new installation package. The new installation package may be used to install the software system at the updated configuration.

In some embodiments, a user may be given options during a reinstallation operation to select between a current installation package and one or more older installation packages, one of which may include the original installation package. In some embodiments, a default selection may be the most current installation package. Some embodiments may not give the user an option to perform an installation with an older installation package.

The device 102 may be any type of computing device that may execute software systems. Common computing devices include personal computers and server computers, and may also include portable cellular telephones, set top boxes, game consoles, portable scanning equipment, laptop computers, network routing equipment, wireless access points, medical instrumentation, scientific instrumentation, or any other device that executes any type of software for which an update may be installed.

The device 102 may have a hardware platform 104 and a software platform 106. The hardware platform 104 may contain various hardware components on which the components of the software platform 106 may be executed. In some cases, the hardware platform 104 may be virtualized and may itself be a software component that operates on a different hardware platform.

The hardware platform 104 may contain a processor 108. In many embodiments the processor 108 may be a single core processor, while other embodiments may have multiple cores, multiple processors, or other configurations that execute instructions in parallel.

The processor 108 may have nonvolatile storage 110 that may be used to store data and executable files when the hardware platform 104 is turned off. The storage 110 may be a hard disk drive, for example, or other nonvolatile storage mechanism.

Random access memory 112 may be volatile or nonvolatile storage that may be accessed by the processor 108. Typical random access memory 112 may be high speed memory that may be quickly accessed by the processor 108 and may contain currently executing programs and data for such programs.

A user interface 118 may be used by various applications to present information to and collect information from a user. Many user interfaces 118 may have a graphical display or other output mechanism and may collect information using keyboards, pointing devices, or other devices. In some cases, the user interface 118 may include audio input and output devices, tactile devices, or other mechanisms.

The hardware platform 104 may contain various interfaces, including network connections 116 and other interfaces 114.

The network connection 116 may be used to communicate across networks to other devices. In some embodiments, updates may be received over a network connection from another device. The network connection 116 may connect to a personal area network, local area network, wide area network, the Internet, or some other network.

The interfaces 114 may include various interfaces through which the processor 108 may access other devices, data, or other components. In one example, the interfaces 114 may include a Universal Serial Bus (USB) interface. A USB connection may be used to connect to a data storage device on which an installation package may be received and stored. An example of such a device may be found in embodiment 200 described later in this specification.

The software platform 106 may include a version management system 108 that may manage one or more installation packages for various software systems, as well as an operating system 110 and various applications 112. In some embodiments, the version management system 108 may manage installation packages for the operation system 110 or one or more of the applications 112.

The version management system 108 may include an installation system 114. The installation system 114 may perform installation tasks, and may receive an installation package and perform various operations to install a software package. In the case of some applications 112, the installation system 114 may unpack a compressed file, create directories, and place various expanded files within those directories as well as other directories. In some cases, the installation system 114 may modify various configuration files, system registry settings, or perform other installation tasks. Such installation tasks may be defined in the installation package used by the installation system 114.

An update system 116 may be included in many embodiments of a version management system 108. The update system 116 may receive updates to a software system and may apply the updates. In some cases, the update system 116 may cause the software system to restart, the hardware system 104 to reboot, or perform other functions to complete the update. The update system 116 may perform many of the functions of the installation system 114 when installing an update.

An update may take on many different forms and may be delivered in many different ways. For example, updates 148 created by a software manufacturer may be stored on a remote server 146 and transmitted through the network 144 to the device 102. Other updates may be changes to configuration files or system state that may happen locally to the device 102 by other services or application, or by user interaction or configuration.

In some embodiments, an update may be received in the same file format and contain similar components as an installation package. In other embodiments, an update may be differently configured from the original installation package.

For example, an installation package for an operating system 110 may be very different from an update to the operating system 110. Such an installation package may include bootable components that create a directory structure and populate the structure with various files, then perform various configuration operations. An update to the operating system may include adding new files, updating existing files, replacing existing files, or performing various configuration changes. The update may be installed while the operating system is executing and may change a small subset of the operating system components.

The update system 116 may also apply an update to an installation package for a software system. When an update is received or when a change is detected, the update system 116 may create a new version of an installation package by applying the update to an existing installation package.

A monitoring system 118 may be present in some embodiments and may detect when an update has been performed. The monitoring system 118 may monitor various installed components of a software system, and when a change to those installed components is detected, may cause an update to be incorporated into an installation package for the software system.

A monitoring system 118 may be useful in embodiments where configuration changes are monitored and tracked as “updates”. Such configuration changes may occur because a user manually changes the configuration settings, or when another application or operating system component changes the configuration settings.

Tracking and updating configuration changes has several useful scenarios. In one use scenario, a user may configure a word processing application with certain elements according to the user's taste. For example, the user may customize menus, configure default fonts, and select a preferred paper size and orientation. The user may also create macros that perform certain functions, as well as set the word processor as a default editor for certain file types. In many cases, the user may have spent a considerable amount of time customizing the application to suit the user's particular tastes. The changes may be stored in several locations, including configuration files for the application, as well as some operating system level settings. All of the user's changes may be monitored using the monitoring system 118, and those changes may be incorporated into an installation package for the application by the update system 116. If the user wishes to reinstall the application at some later time, the application may be installed with all of the user's customizations in place and operable.

In another use scenario, a monitoring system may be used to track updates when the updates are not performed by the version management system 108. For example, some applications may have a function for independently downloading and installing updates. A typical example may be a security system that may receive daily or even hourly threat updates. In such a scenario, the application may download and install updates without using the update system 116 of the version management system 108. In such a case, the monitoring system 118 may detect that an update has occurred and may cause the update system 116 to incorporate the detected update into an installation package.

When an embodiment tracks configuration changes to an application, an update to the installation package may be delayed for a period of time. Such a delay may be useful in situations where a user makes several successive changes to an application and the several changes may be rolled into one update to an installation package at one time.

The update system 116 may perform updates to installation packages as a background process in some embodiments, or may perform updates to installation packages at off peak hours when the device 102 may not be used for other functions. In such embodiments, multiple updates to a software system may be rolled into a single update to an installation package.

The restore system 120 may be used to reinstall an application. The restore system 120 may retrieve an installation package and perform an installation using the installation package. In some embodiments, the restore system 120 may offer options to a user, where the use may select the original installation package or may select an updated installation package. Some such embodiments may present a user with a menu that includes the most up to date installation package as well as one or more other installation packages.

The updated installation packages created by the update system 116 may comprise the original installation package with a separate set of updates. In some cases, the original installation package may not be editable or even readable by the update system 116. In such cases, the update system 116 may create an update package that includes all of the updates applied to the original installation package. When the restore system 120 performs a reinstallation operation, the original installation package may be installed using the restore system 120 or a different installation mechanism, then the restore system 120 may apply the updates after the original installation package is installed.

Such an embodiment may be useful in cases where the version management system 108 may be used to track updates for applications or other software systems that may not be designed to operate specifically with the version management system 108. In such cases, the version management system 108 may monitor changes and updates for many different applications, individual files, complete operating systems, or other software components or systems.

In cases where a software system operates in conjunction with the version management system 108, updates and changes to the software system may include alerts or other communication to the version management system, or may allow simple editing and implementation of installation packages.

In some embodiments, the update installation packages may be edited by the update system 116 such that the updates are incorporated directly into the installation package. For example, an update may change one Dynamic Linked Library file (DLL) within several DLL's for a particular application. When the update is installed on the application, the old DLL may be removed and replaced with the new DLL. Similarly, the update system 116 may update the installation package by editing the previous installation package to remove the old DLL and insert the new DLL.

A registration system 122 may be used to register applications or other software systems with the version management system 108. The registration system 122 may add a new software system to manage by identifying the software system, the components of the software system, and any configuration settings, configuration files, or other parameters that may be included as an update. After registration, the version management system 108 may track changes or updates and create updated installation files for the registered software system.

In some cases, a registration system 122 may receive a configuration file that describes the application to manage in a format such as XML or other declarative manner. Some embodiments may include the configuration file in an original installation package of an application.

In many embodiments, a version management system 108 may monitor several different software systems and create updated installation files for multiple software systems.

A malware checker 156 may be used by the version management system 108 to check any update or newly created installation package for malicious software, such as viruses, worms, Trojan horses, or other malicious software. If malware is found in the updated installation package, that installation package may be discarded, quarantined, or handled appropriately.

When the version management system 108 monitors changes in a software system, the state of both applications and operating system may be captured and stored in an updated installation package. In embodiments where the version management system 108 manages the operating system 110, the version management system 108 may include changes to executables 136 as well as other changes in an updated installation package.

Operating system executables 136 may be any executed file that is part of the operating system. In some embodiments, updates to operating system executables 136 may be performed when the operating system is rebooted. In some cases, an operating system may have a feature whereby updates may be queued for the next reboot, them implemented when the operating system is eventually rebooted.

In many embodiments, system state may be incorporated into and stored as part of an updated installation package. System state may be useful in reinstalling an operating system and many applications so that the overall system can be recreated to the point when the updated installation package was created.

System state may include parameters such as network configuration settings 128, system configuration settings 130, registry settings 132, and hardware settings 134. In many cases, a software system may be dependent on some element of system state for proper operation. By tracking changes to system state and incorporating those changes into updated installation packages, those elements may be recreated when a reinstallation is performed.

Applications 112 may also have executables 138 as well as configuration data 140 and application data 142. Application data 142 may be data created by or used by the application, but may not be included in an updated installation package for the application 112. In many cases, the application data 142 may be managed using a backup system suited to data storage.

Some embodiments of a version management system 108 may monitor changes to configuration data 140 for various applications 112, in addition to monitoring changes to executables 138. When a change is detected, an updated installation package may be created that incorporates any changes to executables 138 and configuration data 140. Examples of locations for configuration data 138 may be configuration files as well as various databases such as an operating system registry 132, Lightweight Directory Access Protocol (LDAP) database, or other location.

In some cases, an application may be affected by data stored in another application's data. For example, a messaging application may reference data stored in a mail system application database. In such an example, changes to the mail system application database may be captured and stored as updates for the messaging application so that then a reinstallation is performed on the messaging application, the appropriate configuration of the mail system application database may be performed so that the messaging application may operate properly.

The installation packages 126 may be stored in a storage device 124. The storage device 124 may be any type of storage mechanism. Many embodiments may keep original installation packages 126 and updated installation packages 126 in the same storage mechanism, while some may store the original and updates installation packages in different locations. Some embodiments, including embodiment 200 presented later in this specification, may have a read only memory location in which the original installation package may be stored, along with a read write memory location in which one or more updated installation packages may be stored.

In some embodiments, an up to date installation package may be created by applying an update to the previously most up to date installation package. After the up to date installation package is completed and verified, the previously most up to date installation package may be deleted. In such an embodiment, the most up to date installation package may be incrementally updated over time. Such embodiments may have the advantage of storing only the most up to date installation package and very little, if any, additional data. In many such embodiments, the original installation package may also be stored so that a user may have the option to return to the original installation if the up to date installation package may be corrupt.

In other embodiments, an up to date installation package may be created by applying all of the updates to the original installation package each time a new update is received. In such an embodiment, all of the updates may be stored as well as the original installation package. Such an embodiment may be capable of creating an installation package on demand. Some such embodiments may be capable of selecting a particular version of an updated installation package and creating the version when the version is requested.

In some such embodiments, an up to date installation package may be stored in the storage device 124 along with the individual updates and the original installation package. Such embodiments may provide a user with a selection of any version for reinstalling a software system. In some such embodiments, the user may be able to select which of the updates to include or exclude from the installation package. For example, a user may be given the option to include updates that include files distributed from the software manufacturer, but exclude updates due to configuration changes performed by a user. Given the user's selection, a custom installation package may be created and the software system reinstalled.

The storage device 124 may be a locally accessible storage device for the device 102. For example, the storage device 124 may be a hard disk storage system, such as the storage 110. In some embodiments, a Universal Serial Bus device, such as the device of embodiment 200, may be used.

In some cases, a remote storage 154 may be used to store installation packages 156. The remote storage 154 may be accessed through a network 144 and may be hosted by a server 150. In some cases, the network 144 may be a local area network and the server 150 may maintain installation packages for several devices within the local area network. In other cases, the network 144 may be a wide area network such as the Internet, and the server 150 may maintain installation packages for very large numbers of devices. In some cases, such as server may provide an offsite storage location that may be used to recreate many software systems for the device 102.

Some embodiments may have two or more different storage locations for installation packages. For example, some embodiments may store an original installation package on a remote storage 154 and updated installation packages in a local storage device 124. One example of such an embodiment may be a configuration where the original installation packages are continually available from a software distributor or manufacturer over the Internet, and updated installation packages may be stored locally. In another example, an installation package may be stored on a read only optical disk, such as a CD or DVD, and updated installation packages may be stored on a hard disk, tape backup, USB connected storage device, or other location.

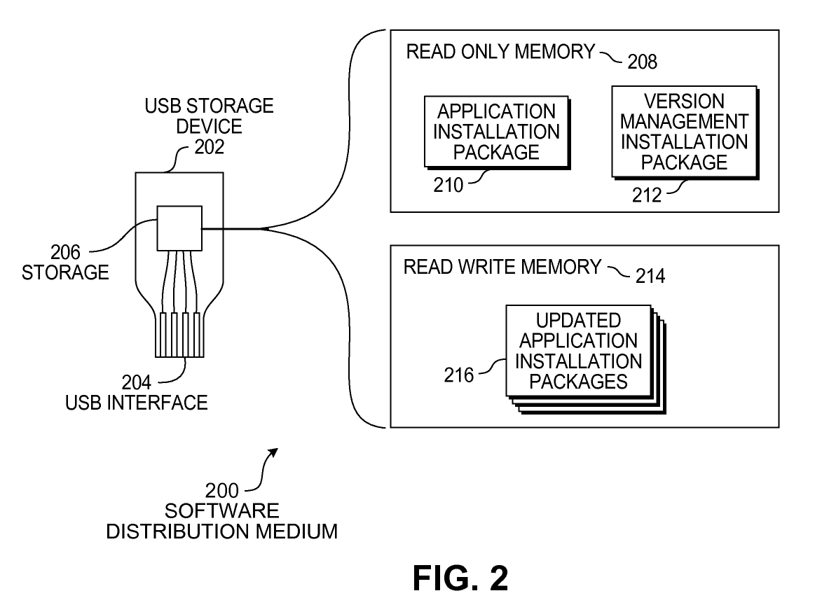

FIG. 2 is a diagram illustration of an embodiment 200 showing a software distribution medium. Embodiment 200 is an example of a medium that contains read only and read write memory, and may be used to store updated installation packages for one or more software systems.

Embodiment 200 is an example of a storage device that may be used for distributing software, as well as storing updated installation packages. As a distribution medium, an installation package may be written to the storage device by a software manufacturer this distributed to an end user. The end user may connect the storage device and install the software system.

Embodiment 200 may be a Universal Serial Bus (USB) storage device 202 that may have a USB interface 204 and a mechanism for storage 206. In the embodiment 200, the storage 206 may be a solid state nonvolatile storage device. Other USB devices may include devices with a mechanical hard disk storage device or some other storage mechanism.

The storage 206 may contain read only memory 208 and read write memory 214. The read only memory 208 may include an original application installation package 210 and may also include a version management system installation package 212. The read write memory 214 may include updated application installation packages 216 that may be created over time by a version management system.

Device 202 may be an example of one mechanism to distribute software systems. A user may plug in the USB interface 204 into a desktop computer, for example, and may install the software system contained in the application installation package 210 as well as the version management system contained in the version management installation package 212. The version management system may monitor updates, create updated installation packages, and store the updated installation packages 216 in the read write memory 214.

In some embodiments, the USB storage device 202 may be installed in a computer and left in place as the computer is used. In some such embodiments, a USB storage device 202 may be installed inside a computer case where the USB storage device 202 is difficult to physically access but in constant communication with a computer processor. One such location may be to plug the USB storage device directly onto a computer motherboard, for example.

In some embodiments, the device 202 may be a bootable device capable of bootstrapping a device using one or more of the installation packages stored on the device or using other software stored on the device. In some cases, the version management system 212 may include a bootable component that may allow a user to select between several installation packages to reinstall an operating system or other software system.

The application installation package 208 and version management installation package 212 may be stored in read only memory 208. In some embodiments, the storage 206 may contain read write memory and the application installation package 208 and version management installation package 212 may be marked as read only. Other embodiments may have separate storage mechanisms for read write and read only memory.

The version management installation package 212 may be used to install a version management system, such as the version management system 108 in embodiment 100.

In some embodiments, other software components may be distributed with the device 202. Such components may include an installation application that may be used to install the various installation packages.

In some embodiments, the read write memory 214 may be used to store updated application installation packages 216 from many different applications, not just the application installed with the application installation package 210.

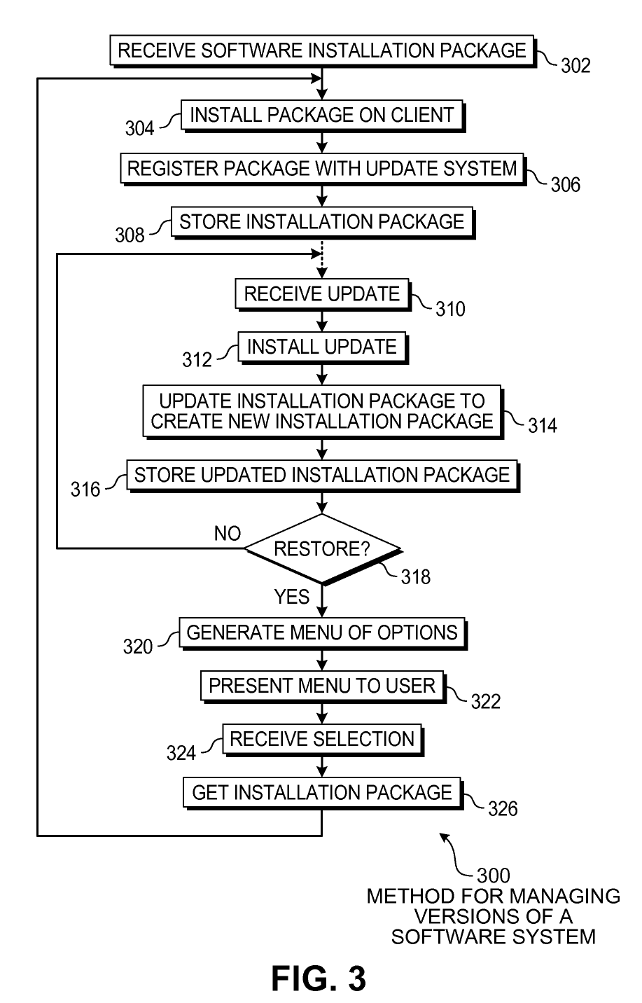

FIG. 3 is a flowchart illustration of an embodiment 300 showing a method for managing versions of a software system. Embodiment 300 is a simplified example of a method that may be performed by a version management system, such as the version management system 108 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a general process performed by a version management system. A software system may be installed from an installation package. After installation, updates to the software system may be detected and an updated installation package may be created. When a restore or reinstallation operation is selected, one of the installation packages may be selected and the software system reinstalled.

A software installation package may be received in block 302. The software installation package may be received by reading from a distribution device, such as the device of embodiment 200, or by other mechanisms. Some embodiments may distribute the software installation package by downloading from an Internet server, for example. Other embodiments may use Compact Disks, Digital Versatile Disks, or other distribution mechanism.

The original software installation package may be installed in block 304.

The software system may be registered in block 306 with an update system. The registration may include identifying the software system and various components of the software system that may be monitored for updates. For example, a complex software system may have many different executable files as well as configuration files and other configuration elements for various components. Each of the executable files, configuration files, and other configuration elements may be monitored for changes.

An update maybe received in block 310 and installed in block 312.

An update may be any change to any monitored component. In some cases, an update may be distributed from a software manufacturer and may include changes to various executable and configuration files for a software system. In some cases, an update may be a configuration setting or change of system state that may affect the operation of the software system.

When an update is detected, an updated installation package may be created from an existing installation package in block 314, and the updated installation package may be stored in block 316.

The process may loop back from block 318 to block 310 under normal operations.

A user may select a restore or reinstall operation in block 318. A reinstall operation may be selected for various reasons. For example, a user may wish to reinstall a software system due to a virus infection, a catastrophic storage system failure, a configuration problem, migrating to a new operating system or new hardware, or some other reason.

When a user chooses to restore in block 318, a menu of options may be created in block 320. The options may be selected from one or more installation packages. In some cases, multiple installation packages may be created as updates are installed. Some embodiments may present options for each of the various installation packages so that a user may be able to select a specific installation package. In many embodiments, the menu in block 320 may include an option to reinstall the original installation package.

The menu may be presented to a user in block 322 and a selection may be received in block 324. The selected installation package may be retrieved in block 326 and installed in block 304.

In some embodiments, an installation package may be created on demand by applying multiple stored updates to an original installation package. In some such embodiments, a user may be able to select specific types of updates to include others to exclude, or may be able to select a configuration as of a specific date. Such embodiments may store each update individually and be capable of applying the updates to an original installation package to create a custom installation package.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method being performed on a computer processor, said method comprising:
receiving a first installation package;
installing said first installation package on a client device to create an application on said client device;
storing said first installation package on a storage mechanism;
receiving an update to said application;
installing said update to said application on said client device;
updating said first installation package to create a second installation package, said second installation package comprising at least a portion of said update and being able to reinstall said application; and
storing said second installation package.

2. The method of claim 1 further comprising:
replacing said first installation package with said second installation package on said storage mechanism.

3. The method of claim 1 further comprising:
receiving a request to reinstall said application on said client device; and
using said second installation package to reinstall said application on said client device.

4. The method of claim 3 further comprising:
on a user interface, presenting a first option for reinstalling said first installation package and a second option for reinstalling said second installation package; and
receiving a selection of said second option from said user interface.

5. The method of claim 1 further comprising:
performing a malware check on said second installation package prior to said storing said second installation package.

6. The method of claim 1 further comprising:
registering said application with an update service, said update service being capable of causing said updating said first installation package to be performed.

7. The method of claim 1, said update comprising a change to a configuration setting, said change being performed by a user.

8. The method of claim 1, said update comprising a change to a system state.

9. The method of claim 1, said updating said first installation package being performed as a background process.

10. A system comprising:
a storage medium;
a first installation package stored on said storage medium, said first installation package being capable of installing an application on a client device;
a version manager installation package stored on said storage medium, said version manager installation package capable of being installed on said client device as a version manager application, said version manager application capable of operating on said client device and performing a method comprising:
receiving an update to said application;
updating said first installation package to create a second installation package, said second installation package comprising at least a portion of said update and being able to reinstall said application; and
storing said second installation package.

11. The system of claim 10, said storage medium comprising a read only area and a read write area, said first installation package being stored in said read only area.

12. The system of claim 11, said second installation package being stored in said read write area.

13. The system of claim 10 further comprising:
a remote storage medium, said second installation package being stored in said remote storage medium.

14. The system of claim 13, said remote storage medium being accessed over a network.

15. The system of claim 10 further comprising:
a monitoring system incorporated into said version manager installation package, said monitoring system performing a method comprising:
detecting said update; and
causing said updating said first installation package to be performed in response to said detecting.

16. The system of claim 10, said storage medium being a solid state memory device.

17. The system of claim 16, said solid state memory device having a Universal Serial Bus connection to said client device.

18. A method comprising:
installing a first installation package on a client device to create an application, said application being in a first state;
receiving an update to said application, said application being in a second state when said update is applied to said application;
creating a second installation package from said first installation package and said update, said second installation package being capable of installing said application on said client device in said second state; and
storing said second installation package.

19. The method of claim 18 further comprising:
receiving a second update to said application, said application being a third state when said update is applied to said application;
creating a third installation package from said second installation package and said second update, said third installation package being capable of installing said application on said client device in said third state; and
storing said third installation package.

20. The method of claim 19 further comprising:
deleting said second installation package after said storing said third installation package.
